(19) United States
(12) Patent Application Publication
(10) Pub. No.: US 2021/0205831 A1
(43) Pub. Date: Jul. 8, 2021

(54) PAINT SUPPLY SYSTEM

(71) Applicant: TRINITY INDUSTRIAL CORPORATION, Toyota-shi, Aichi (JP)

(72) Inventor: Keisuke NAKURA, Toyota-shi (JP)

(73) Assignee: TRINITY INDUSTRIAL CORPORATION, Toyota-shi, Aichi (JP)

(21) Appl. No.: 17/056,389

(22) PCT Filed: Apr. 3, 2019
(86) PCT No.: PCT/JP2019/014731

§ 371 Date: Nov. 17, 2020

(30) Foreign Application Priority Data
Jul. 2, 2018 (JP) 2018-125793

(51) Int. Cl. B05B 12/08; B05B 12/00; B05B 15/40; B05B 14/40

(52) U.S. Cl. CPC B05B 12/085; B05B 14/40; B05B 15/40; B05B 12/006

(57) ABSTRACT

A paint supply system includes: a paint supply pump; a paint tank connected to an inlet of the paint supply pump; a paint feed path connected to an outlet of the paint supply pump to feed paint to the coating machine; a paint return path configured to return the paint from the coating machine to the paint tank; and a control apparatus configured to exert feedback control on a discharge amount of the paint supply pump using control parameter values recorded on a table. On the table, the control parameter values are recorded as being classified under a plurality of levels so that the pressure of the paint at a predetermined specified location attains a target pressure more quickly when the pressure of the paint at the specified location is outside a first pressure range including the target pressure than when falling within the first pressure range.

### TECHNICAL FIELD

The present disclosure relates to a paint supply system that feeds paint using a paint supply pump.

### BACKGROUND ART

In a paint supply system disclosed in Patent Literature 1, a normal operation and a save operation are switched according to the operation status of a coating machine. In the normal operation, control is exerted so that the discharge flow rate of a paint supply pump attains a set normal flow rate. In the save operation, control is exerted so that the discharge flow rate of the paint supply pump becomes smaller than the set normal flow rate.

### CITATIONS LIST

### Patent Literature

Patent Literature 1: Japanese Unexamined Patent Application Publication No. 2009-154042 (paragraphs [0062] to [0068], FIG. 6)

### SUMMARY OF INVENTION

### Technical Problems

The paint supply system disclosed in Patent Literature 1 is desired, for example, to maintain the pressure of paint at a particular location, such as the original pressure of the paint in the coating machine, at a target pressure.

### Solutions to Problems

A paint supply system according to the present disclosure includes: a paint supply pump; a paint tank connected to an inlet of the paint supply pump; a paint feed path connected to an outlet of the paint supply pump to feed paint to a coating machine; a paint return path configured to return the paint from the coating machine to the paint tank; and a control apparatus configured to exert feedback control on a discharge amount of the paint supply pump so that a pressure of the paint at a predetermined specified location out of the paint feed path, the paint return path, and the coating machine attains a target pressure. The control apparatus includes a table on which control parameter values for the feedback control are recorded, and controls the discharge amount of the paint supply pump using the control parameter values recorded on the table. On the table, the control parameter values are recorded as being classified under a plurality of levels so that the pressure of the paint at the specified location attains the target pressure more quickly when the pressure of the paint at the specified location is outside a first pressure range including the target pressure than when the pressure of the paint at the specified location falls within the first pressure range.

### BRIEF DESCRIPTION OF DRAWINGS

FIG. 1 is a schematic configuration illustration of a paint supply system according to one embodiment of the present disclosure.

FIG. 2 is a schematic configuration illustration of a coating machine and its surroundings.

FIG. 3 is a table of control parameter values.

FIG. 4 is a graph of an exemplary transition of an observed pressure (the average value P of P1 and P2).

FIG. 5 is a flowchart of a pump control process.

FIG. 6 is a flowchart of an error detecting process.

### DESCRIPTION OF EMBODIMENT

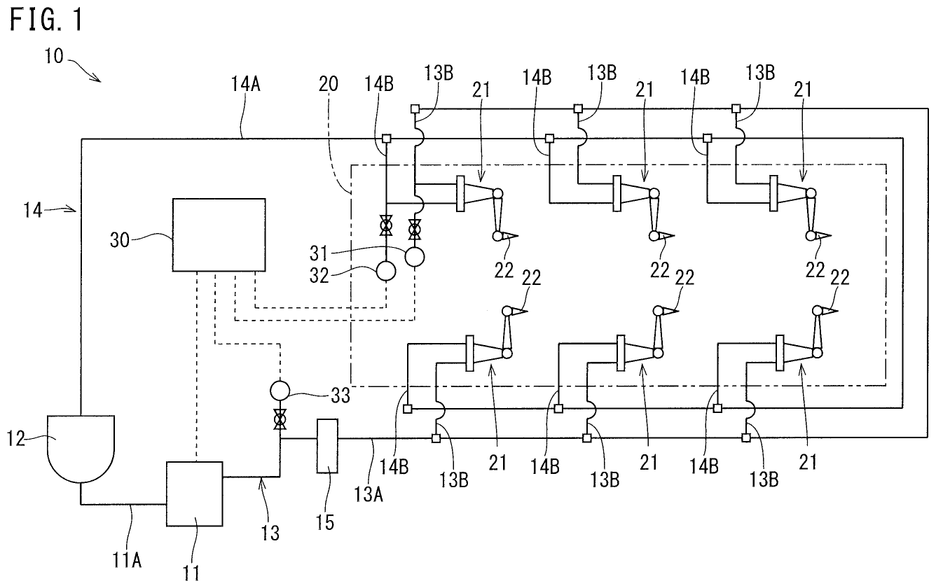

FIG. 1 illustrates a paint supply system 10 according to an embodiment of the present disclosure. The paint supply system 10 includes: a paint supply pump 11; a paint tank 12 connected to an inlet of the paint supply pump 11 via a connection pipe 11A; a paint feed path 13 connected to an outlet of the paint supply pump 11 to feed paint to coating machines 21 in a coating booth 20; and a paint return path 14 returning the paint from the coating machine 21 to the coating tank 12. A paint filter 15 is interposed in the paint feed path 13.

In the coating booth 20, a plurality of coating machines 21 are provided. The paint feed path 13 consists of a feed path main pipe 13A connected to the outlet of the paint supply pump 11 and a plurality of feed path branch pipes 13B branching from the feed path main pipe 13A. To each of the plurality of feed path branch pipes 13B, one coating machine 21 is connected. The paint return path 14 consists of a return path main pipe 14A connected to the paint tank 12 and a plurality of return path branch pipes 14B branching from the return path main pipe 14A. To each of the plurality of return path branch pipes 14B, one coating machine 21 is connected. Note that, the paint filter 15 is provided on the feed path main pipe 13A at the portion between the feed path branch pipe 13B nearest to the paint supply pump 11, that is, the most-upstream feed path branch pipe 13B, and the paint supply pump 11.

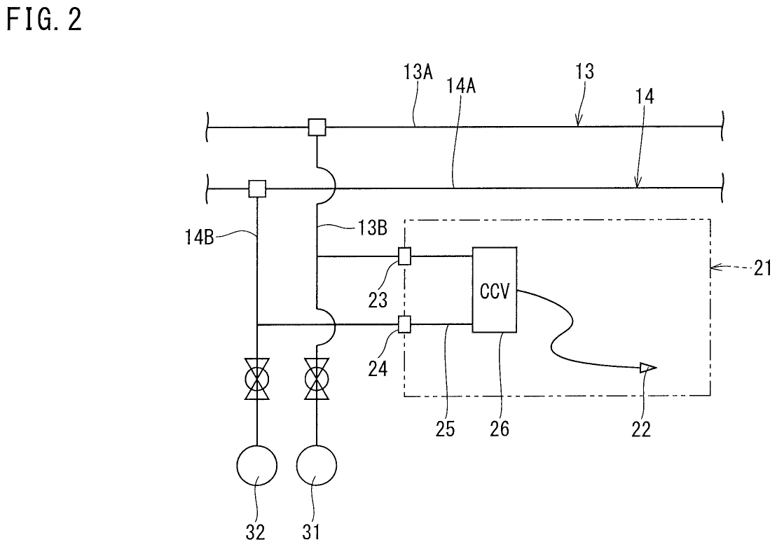

Each coating machine 21 is formed of a multi-axis multi-joint robot that includes a coating gun 22. Specifically, as illustrated in FIG. 2, the coating machine 21 is provided with a flow-in port 23 connected to the feed path branch pipe 13B, a flow-out port 24 connected to the return path branch pipe 14B, and an intra-coating machine channel 25 communicating with the flow-in port 23 and the flow-out port 24. A color change valve 26 is interposed in the intra-coating machine channel 25. To the color change valve 26, the coating gun 22 is connected. Note that, in the paint supply system 10, the paint stored in the paint tank 12 flows through the connection pipe 11A, the paint feed path 13, the intra-coating machine channel 25, and the paint return path 14, to return to the paint tank 12.

The paint supply pump 11 is formed of a motor-driven plunger pump whose output is adjustable by inverter control. The paint supply system 10 includes a control apparatus 30 that controls the discharge amount of the paint supply pump 11.

To the control apparatus 30, a first pressure sensor 31, a second pressure sensor 32, and a third pressure sensor 33 are connected. The first pressure sensor 31 detects the pressure of the paint in the feed path branch pipe 13B farthest from the paint supply pump 11, that is, the most-downstream feed path branch pipe 13B. The second pressure sensor 32 detects the pressure of the paint in the return path branch pipe 14B nearest to the paint tank 12, that is, the most-downstream return path branch pipe 14B. The third pressure sensor 33 detects the discharging pressure of the paint supply pump 11. Specifically, the third pressure sensor 33 detects the pressure of the paint at the portion between the paint supply tank 11 and the paint filter 15 in the feed path main pipe 13A. The control apparatus 30 receives detection signals from the pressure sensors 31, 32, 33.

The control apparatus 30 exerts feedback control on the discharge amount of the paint supply pump 11. Specifically, the control apparatus 30 performs the PID operation so that the original pressure of the paint in the coating machine 21 farthest from the paint supply pump 11, that is, the most-downstream coating machine 21 (in more detail, the original pressure of the color change valve 26), attains a preset target pressure P′. Based on the operation result, the control apparatus 30 adjusts the control voltage output to an inverter. Thus, the control apparatus 30 exerts feedback control on the paint supply pump 11.

Here, the control apparatus 30 adopts, as the original pressure of the paint in the coating machine 21, an average value P=(P1+P2)/2 of a pressure P1 of the paint detected by the first pressure sensor 31 and a pressure P2 of the paint detected by the second pressure sensor 32. Then, the control apparatus 30 adopting the average value P of P1 and P2 as the observed pressure outputs the control voltage to the inverter so that the observed pressure attains the target pressure P′. Thus, while it is difficult to directly measure the original pressure of the paint in the coating machine 21, the original pressure of the paint in the coating machine 21 is easily estimated.

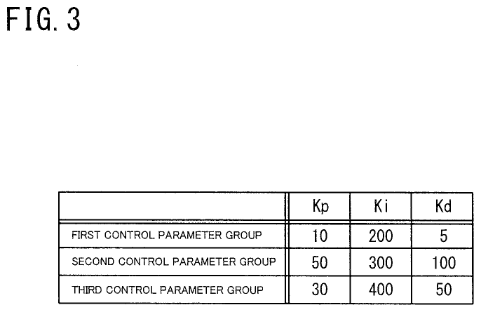

The control apparatus 30 includes a table on which control parameter values of the PID control (that is, proportional parameters Kp, integral parameters Ki, and differential parameters Kd) are recorded. FIG. 3 is an example of the table of the control apparatus 30. With reference to FIG. 3, on the table, three control parameter groups are recorded; in which the proportional parameters Kp, the integral parameters Ki, and the differential parameters Kd each form one control parameter group. The proportional parameters Kp of the first control parameter group are set to be smaller than the proportional parameters Kp of the other two control parameter groups (that is, the second control parameter group and the third control parameter group). The proportional parameters Kp of the second control parameter group are set to be greater than the proportional parameters Kp of the third control parameter group. Note that, in the example of FIG. 3, while the integral parameters Ki and the differential parameters Kd are different from each other in value among the three control parameter groups, they may be identical to each other in value.

In the control apparatus 30 controlling the paint supply pump 11, control parameter values of different control parameter groups are used between the case where the observed pressure (the average value P of P1 and P2) falls within a first pressure range including the target pressure P′ and the case where the observed pressure is outside the first pressure range. In the present embodiment, the difference of the first pressure range from the target pressure P′ falls within ΔP (where ΔP>0) (that is, the range from P′−ΔP to P′+AP inclusive).

Specifically, when the observed pressure (the average value P of P1 and P2) falls within the first pressure range, the control apparatus 30 controls the paint supply pump 11 using the control parameter values of the first control parameter group; when the observed pressure is outside the first pressure range, the control apparatus 30 controls the paint supply pump 11 using the control parameter values of the second control parameter group or the third control parameter group. Here, the proportional parameters Kp of the first control parameter group are smaller than the proportional parameters Kp of the second control parameter group and the third control parameter group. Therefore, when the observed pressure falls within the first pressure range, the observed pressure is easily maintained to be in the first pressure range. This facilitates maintaining the observed pressure at the target pressure P′.

When the observed pressure (the average value P of P1 and P2) exceeds the upper limit value of the first pressure range (that is, when observed pressure>P′+ΔP), the control apparatus 30 controls the paint supply pump 11 using the control parameter values of the second control parameter group; when the observed pressure is lower than the lower limit value of the first pressure range (that is, when the observed pressure <P′−ΔP), the control apparatus 30 controls the paint supply pump 11 using the control parameter values of the third control parameter group. Here, when the difference of the observed pressure from the target pressure P′ is identical, the observed pressure can attain the target pressure P′ more quickly with the control parameter values of the second control parameter group than with the control parameter values of the third control parameter group. Thus, the paint supply system 10 according to the present embodiment is less likely to suffer an excessive increase in the observed pressure. Note that, when the observed pressure exceeds a preset stipulated voltage, the paint supply system 10 is shut down.

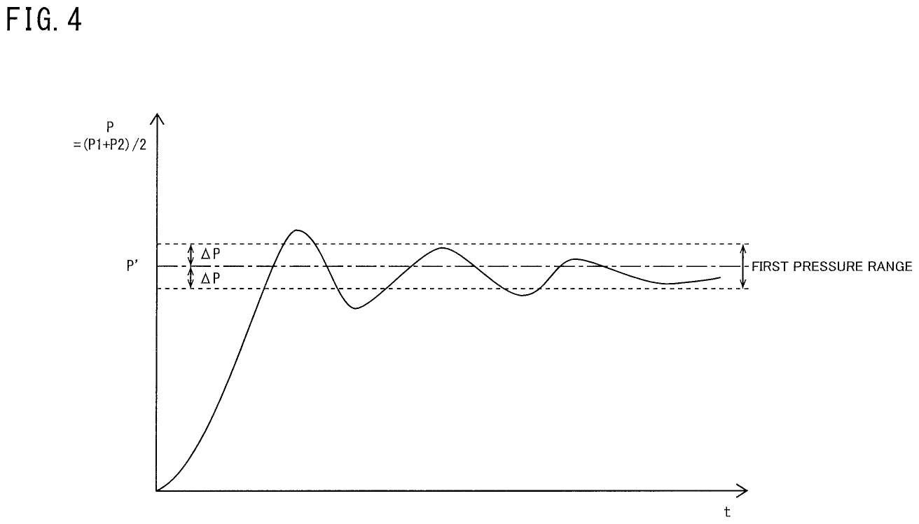

FIG. 4 shows an exemplary transition of the observed pressure (the average value P of P1 and P2). With reference to FIG. 4, when the paint supply pump 11 is turned on, the observed pressure increases. Until the observed pressure reaches the first pressure range, the control apparatus 30 controls the paint supply pump 11 using the control parameter values of the third control parameter group. When the observed pressure has risen to reach the lower limit value of the first pressure range, the control apparatus 30 controls the paint supply pump 11 using the control parameter values of the first control parameter group. This reduces the discharge amount of the paint supply pump 11 and slows the increase of the observed pressure.

When the observed pressure exceeds the target pressure P′ within the first pressure range, the control apparatus 30 controls the paint supply pump 11 so as to reduce the observed pressure while maintaining use of the control parameter values of the first control parameter group. That is, the discharge amount of the paint supply pump 11 is suppressed. In the example in FIG. 4, the pressure overshoots, that is, the observed pressure exceeds the upper limit value of the first pressure range. When the observed pressure exceeds the upper limit value of the first pressure range, the control apparatus 30 controls the paint supply pump using the control parameter values of the second control parameter group. This further suppresses the discharge amount of the paint supply pump and expedites the reduction of the observed pressure. When the observed pressure has reduced to reach the upper limit value of the first pressure range, the control apparatus 30 controls the paint supply pump again using the control parameter values of the first control parameter group. As a result, the discharge amount of the paint supply pump 11 increases and the reduction of the observed pressure becomes slow.

In this manner, the control apparatus 30 selectively uses the control parameter values depending on whether the observed pressure falls within the first pressure range. As a result, when the observed pressure is outside the first pressure range, the observed pressure quickly falls within the first pressure range; when the observed pressure falls within the first pressure range, the observed pressure is less likely to become outside the first pressure range. Furthermore, the control apparatus 30 selectively uses the control parameter values depending on whether the observed pressure is greater or smaller than the first pressure range. As a result, the observed pressure is prevented from largely exceeding the upper limit value of the first pressure range and the paint supply system 10 becomes less likely to shut down.

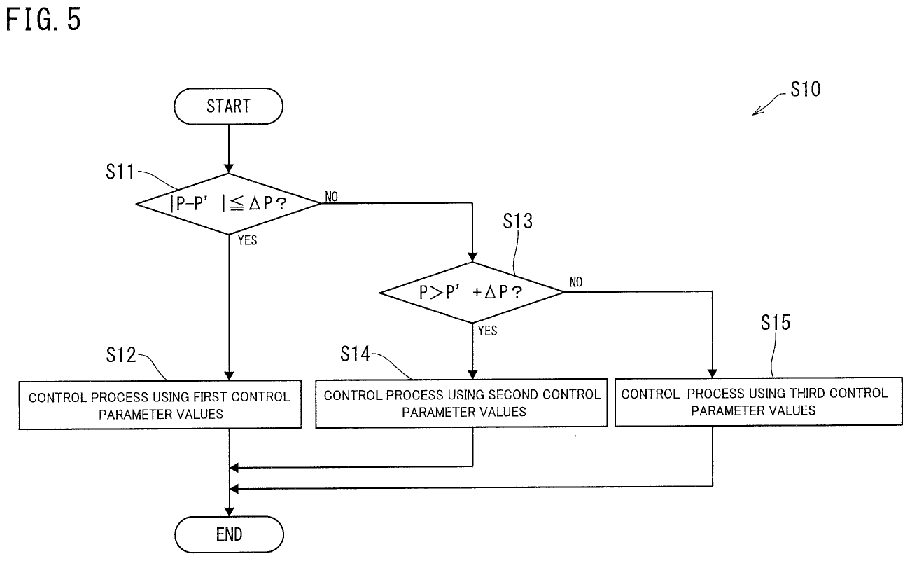

FIG. 5 shows a pump control process S10 which is repeatedly executed by the control apparatus 30 in controlling the discharge amount of the paint supply pump 11 by a predetermined cycle. In the pump control process S10, firstly, whether or not the difference between the average value P of the pressure P1 and the pressure P2 and the target pressure P′(|P−P′|) is ΔP or less, that is, whether or not the average value P falls within the first pressure range, is determined (Step S11). When the difference between the average value P and the target pressure P′ is ΔP or less (Yes in Step S11), the PID control using the first control parameter values in FIG. 3 is exerted (Step S12), and the pump control process S10 ends. When the difference between the average value P and the target pressure P′ is not ΔP or less, that is, when the average value P does not fall within the first pressure range (No in Step S11), whether or not P>P′+ΔP is satisfied is determined (Step S13). When P>P′+ΔP, that is, when the average value P exceeds the first pressure range (Yes in Step S13), the PID control using the second control parameter values in FIG. 3 is executed (Step S14) and the pump control process S10 ends. When P>P′+ΔP is not satisfied, that is, when the average value P is lower than the first pressure range (No in Step S13), the PID control using the third control parameter values in FIG. 3 is executed (Step S15) and the pump control process S10 ends.

In the paint supply system 10, the control apparatus 30 monitors the paint filter 15 using the third pressure sensor 33. Here, the third pressure sensor 33 detects the pressure of the paint at the portion between the paint supply tank 11 and the paint filter 15 in the feed path main pipe 13A. Accordingly, when any error such as clogging occurs at the paint filter 15, the pressure P3 detected by the third pressure sensor 33 becomes high. Thus, the error of the paint filter 15 can be detected.

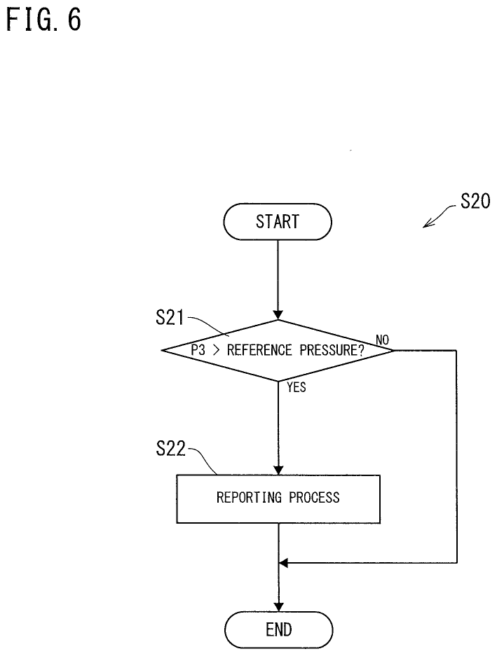

Specifically, any error of the paint filter 15 is detected by the control apparatus 30 repeatedly executing an error detecting process S20 in FIG. 6 by a predetermined cycle. In the error detecting process S20, firstly, whether or not the pressure P3 detected by the third pressure sensor 33 exceeds a predetermined reference pressure is determined (Step S21). When the pressure P3 exceeds the reference pressure (Yes in Step S21), a reporting process (Step S22) is executed and the error detecting process S20 ends. In the reporting process (Step S22), the error of the paint filter 15 is reported. When the pressure P3 is equal to or lower than the reference pressure (No in Step S21), the error detecting process S20 ends.

In the paint supply system 10 according to the present embodiment, on the table, the control parameter values for feedback control exerted by the control apparatus 30 are recorded. The control parameter values are recorded as being classified under a plurality of levels so that the original pressure of the paint in the coating machine 21 outside the first pressure range attains the target pressure P′ more quickly than the original pressure within the first pressure range. Therefore, as compared to the case where there is just one type of control parameter values is recorded, the original pressure of the paint in the coating machine 21 is easily maintained at the target pressure P′. As a result, the discharging pressure of the paint in the coating machine 21 stabilizes. Furthermore, in the present embodiment, since the original pressure of the paint in the most-downstream coating machine 21 is controlled, the original pressure of the paint in a plurality of coating machines 21 can be controlled to be at least the target pressure P′.

Here, the paint supply system 10 includes: the first pressure sensor 31 configured to detect the pressure of the paint in the feed path branch pipe 13B connected to the coating machine 21; and the second pressure sensor 32 configured to detect the pressure of the paint in the return path branch pipe 14B connected to the coating machine 21. The average value P=(P1+P2)/2 of the pressure P1 of the paint detected by the first pressure sensor 31 and the pressure P2 of the paint detected by the second pressure sensor 32 is adopted as the original pressure of the paint in the coating machine 21. Thus, the paint supply system 10 is capable of controlling the original pressure of the paint in the coating machine 21 despite its being incapable of directly detecting the original pressure of the paint in the coating machine 21.

Furthermore, in the paint supply system 10 according to the present embodiment, the control parameter values are recorded as being classified under a plurality of levels so that the original pressure of the paint in the coating machine 21 (in more detail, the average value of P1 and P2) exceeding the first pressure range attains the target pressure P′ more quickly than the original pressure of the paint in the coating machine 21 lower than the first pressure range. This prevents the original pressure of the paint in the coating machine 21 from becoming excessively high, and improves safety of the channel through which the paint flows.

### Other Embodiments

(1) The first pressure range is just required to include the target pressure P. The difference between the target pressure P and the upper limit value of the first pressure range may not be identical to the difference between the target pressure P and the lower limit value of the first pressure range.

(2) In the above-described embodiment, the control apparatus 30 adopts the original pressure of the paint in the coating machine 21 (in more detail, the original pressure of the color change valve 26) as the observed pressure, and controls the paint supply pump 11 so that the observed pressure attains the target pressure. Here, in the channel through which the paint flows, the pressure) of the paint in a predetermined specified location should be adopted as the observed pressure. For example, in the return path main pipe 14A, the pressure of the paint at the portion between the most-downstream return path branch pipe 14B and the paint tank 12 may be adopted as the observed pressure. Alternatively, the pressure of the paint detected by the third pressure sensor 33 may be adopted as the observed pressure. Note that, the target pressure in this case may be a value identical to or different from the target pressure in the above-described embodiment.

(3) In the above-described embodiment, the control apparatus 30 controls the paint supply pump 11 so that the original pressure of the paint in the most-downstream coating machine 21 attains the target pressure P′. Here, the control apparatus 30 may control the paint supply pump 11 so that the original pressure of the paint in an arbitrarily selected coating machine 21 (for example, the most-upstream coating machine 21) attains a target pressure P″. Note that, P″ may be a value identical to or different from P′.

(4) The paint supply system 10 may supply the paint to just one coating booth 20 or to a plurality of coating booths 20.

(5) One of the second control parameter group and the third control parameter group may be dispensed with. For example, in a configuration dispensing with the third control parameter group, when the average value P becomes outside the first pressure range, the paint supply pump 11 is controlled using the parameter values of the second control parameter group.

(6) The paint supply system 10 may dispense with the third pressure sensor 33.

### REFERENCE SIGNS LIST

10 paint supply system

11 paint supply pump

12 paint tank

13 paint feed path

14 paint return path

15 paint filter

21 coating machine

30 control apparatus

31 first pressure sensor

32 second pressure sensor

33 third pressure sensor

1-5. (canceled)

6. A paint supply system comprising:
a paint supply pump;
a paint tank connected to an inlet of the paint supply pump;
a paint feed path connected to an outlet of the paint supply pump to feed paint to a coating machine;
a paint return path configured to return the paint from the coating machine to the paint tank; and
a control apparatus configured to exert feedback control on a discharge amount of the paint supply pump so that a pressure of the paint at a predetermined specified location out of the paint feed path, the paint return path, and the coating machine attains a target pressure, wherein
the control apparatus includes a table on which control parameter values for the feedback control are recorded, and controls the discharge amount of the paint supply pump using the control parameter values recorded on the table, and
on the table, the control parameter values are recorded as being classified under a plurality of levels so that the pressure of the paint at the specified location attains the target pressure more quickly when the pressure of the paint at the specified location is outside a first pressure range including the target pressure than when the pressure of the paint at the specified location falls within the first pressure range.

7. The paint supply system according to claim 6, wherein
on the table, the control parameter values are recorded as being classified under at least three levels so that the pressure of the paint at the specified location attains the target pressure more quickly when the pressure of the paint at the specified location exceeds the first pressure range than when the pressure of the paint at the specified location is lower than the first pressure range.

8. The paint supply system according to claim 6, wherein the control apparatus controls the discharge amount of the paint supply pump so that an original pressure of the paint in the coating machine attains the target pressure.

9. The paint supply system according to claim 7, wherein the control apparatus controls the discharge amount of the paint supply pump so that an original pressure of the paint in the coating machine attains the target pressure.

10. The paint supply system according to claim 6, further comprising
a plurality of the coating machines, wherein
the paint feed path is provided with a feed path main pipe connected to the outlet of the paint supply pump and a plurality of feed path branch pipes branching from the feed path main pipe and respectively connected to the plurality of coating machines,
the paint return path is provided with a return path main pipe connected to the paint tank and a plurality of return path branch pipes branching from the return path main pipe and respectively connected to the plurality of coating machines,
the pressure sensor includes a first pressure sensor configured to detect a pressure of the paint in the feed path branch pipe connected to selected one of the plurality of coating machines and a second pressure sensor configured to detect a pressure of the paint in the return path branch pipe connected to the selected one of the plurality of coating machines, and
the control apparatus controls the discharge amount of the paint supply pump so that an average value of the pressure of the paint detected by the first pressure sensor and the pressure of the paint detected by the second pressure sensor attains the target pressure.

11. The paint supply system according to claim 7, further comprising
a plurality of the coating machines, wherein
the paint feed path is provided with a feed path main pipe connected to the outlet of the paint supply pump and a plurality of feed path branch pipes branching from the feed path main pipe and respectively connected to the plurality of coating machines,
the paint return path is provided with a return path main pipe connected to the paint tank and a plurality of return path branch pipes branching from the return path main pipe and respectively connected to the plurality of coating machines,
the pressure sensor includes a first pressure sensor configured to detect a pressure of the paint in the feed path branch pipe connected to selected one of the plurality of coating machines and a second pressure sensor configured to detect a pressure of the paint in the return path branch pipe connected to the selected one of the plurality of coating machines, and
the control apparatus controls the discharge amount of the paint supply pump so that an average value of the pressure of the paint detected by the first pressure sensor and the pressure of the paint detected by the second pressure sensor attains the target pressure.

12. The paint supply system according to claim 6, further comprising:
a paint filter provided at the paint feed path; and
a discharging pressure sensor detecting a discharging pressure of the paint supply pump.

13. The paint supply system according to claim 7, further comprising:
a paint filter provided at the paint feed path; and
a discharging pressure sensor detecting a discharging pressure of the paint supply pump.

14. The paint supply system according to claim 8, further comprising:
a paint filter provided at the paint feed path; and
a discharging pressure sensor detecting a discharging pressure of the paint supply pump.

15. The paint supply system according to claim 9, further comprising:
a paint filter provided at the paint feed path; and
a discharging pressure sensor detecting a discharging pressure of the paint supply pump.

16. The paint supply system according to claim 10, further comprising:
a paint filter provided at the paint feed path; and
a discharging pressure sensor detecting a discharging pressure of the paint supply pump.

17. The paint supply system according to claim 11 further comprising:
a paint filter provided at the paint feed path; and
a discharging pressure sensor detecting a discharging pressure of the paint supply pump.
